(19) United States
(12) Patent Application Publication
(10) Pub. No.: US 2022/0290463 A1
(43) Pub. Date: Sep. 15, 2022

(54) DUAL-CODE-VARIABLE LOCK CORE

(71) Applicant: SINOX CO., LTD, New Taipei City (TW)

(72) Inventor: Chien-Hung WU, New Taipei City (TW)

(73) Assignee: SINOX CO., LTD, New Taipei City (TW)

(21) Appl. No.: 17/577,781

(22) Filed: Jan. 18, 2022

(30) Foreign Application Priority Data
Mar. 9, 2021 (TW) 110202501

(51) Int. Cl. E05B 37/02

(52) U.S. Cl. CPC E05B 37/02

(57) ABSTRACT

A dual-code-variable lock core is provided, including a first code component, a code wheel arranged outside the first code component, and a second code component arranged at one side of the code wheel. When the code wheel rotates to a first unlocking position, the first code component may move to perform a code change on the dual-code-variable lock core; and when the code wheel rotates to a second unlocking position, the second code component may move to perform the code change on the dual-code-variable lock core.

### TECHNICAL FIELD

The present utility model relates to a dual-code-variable lock core.

### BACKGROUND

In public places such as offices, stores, campuses, stations, and gyms, to display or temporarily store items, window cabinets, lockers, and the like are equipped with locks to prevent deliberate theft or unintentional access.

Common locks used for the above public places include key locks and combination locks. The key locks are inconvenient to manage and easy to lose. In contrast, codes of the combination locks can be set by users without keys. Therefore, the combination locks do not have trouble as the above key locks.

During using the combination locks, the users set the codes according to their preferences. However, conventional combination locks can only be provided with one group of codes or two groups of related codes. For example, a first group of codes and a second group of codes are spaced by a fixed number. Therefore, it is difficult to meet the requirement of multiple people sharing or individual use. On the other hand, the conventional combination locks only use one code change component, which is not conducive to structural design changes. Base on the above, there is still a space for improving the conventional combination locks.

### SUMMARY

An objective of the present utility model is to provide a dual-code-variable lock core used for a combination lock, which has better convenience of use and resolves the above problems in the related art.

Another objective of the present utility model is to provide a dual-code-variable combination lock, which has better convenience of use and resolves the above problems in the related art.

The dual-code-variable lock core includes a first code component, a code wheel arranged outside the first code component, and a second code component arranged at one side of the code wheel. When the code wheel rotates to a first unlocking position, the first code component may move to perform a code change on the dual-code-variable lock core; and when the code wheel rotates to a second unlocking position, the second code component may move to perform the code change on the dual-code-variable lock core.

In embodiments of the present utility model, the dual-code-variable lock core further includes a first unlocking component and a second unlocking component. The first unlocking component extends in a first axial direction, the first code component is sleeved on the first unlocking component, the code wheel is sleeved outside the first code component, the second code component is arranged in the code wheel in a manner of surrounding the first code component, and the second code component is synchronously rotatable with the code wheel through a second code component acting force between the second code component and the code wheel. The second unlocking component is arranged at an outer side of the code wheel. When the code wheel rotates to the first unlocking position, the first code component may move to be separated from or engaged with the code wheel; and when the code wheel rotates to the second unlocking position, the second unlocking component may move to be separated from or engaged with the second code component.

In the embodiments of the present utility model, the first unlocking position and the second unlocking position are independently defined.

In the embodiments of the present utility model, when the first code component is separated from the code wheel, the code wheel is independently rotatable relative to the first code component; and when the second unlocking component is engaged with the second code component, the code wheel is capable of being pushed by an external force which is greater than the second code component acting force for rotating independently relative to the second code component.

In the embodiments of the present utility model, the first code component is provided with a first code component outer edge convex piece. The code wheel is provided with a first inner edge and a second inner edge. The second code component is arranged in the second inner edge of the code wheel in the manner of surrounding the first code component, and is provided with a second code component outer edge and an engaging portion. The second code component is synchronously rotatable with the code wheel through a second code component acting force between the second code component outer edge and the second inner edge. The second unlocking component is provided with an engaging member. When the code wheel is located in the first unlocking position, the first code component may move in the first axial direction to make the first code component outer edge convex piece separated from or engaged with the first inner edge. When the code wheel is located in the second unlocking position, the second unlocking component may move in the first axial direction to make the engaging member separated from or engaged with the engaging portion.

In the embodiments of the present utility model, when the first code component outer edge convex piece is separated from the first inner edge, the code wheel may rotate independently relative to the first code component; and when the engaging member is engaged with the engaging portion, the code wheel may be pushed by the external force, to independently rotate relative to the second code component.

In the embodiments of the present utility model, the second code component outer edge is provided with an elastic convex portion, the second inner edge is provided with a limiting concave portion, and the second code component is rotatable to make the elastic convex portion at least partially enter the limiting concave portion.

The dual-code-variable combination lock of the present utility model includes a housing, a dual-code-variable lock core, a limiting member, a first control member, and a second control member. The dual-code-variable lock core is arranged in the housing. The limiting member is inserted into the housing and located at one side of the dual-code-variable lock core, and is rotatable relative to a second axial direction. The first control member is connected to the limiting member, to control the movement of the first code component and the rotation of the limiting member. The second control member is connected to the limiting member, to control the movement of the second code component and the rotation of the limiting member.

In the embodiments of the present utility model, the limiting member includes a baffle plate, a limiting member rotation shaft, and a limiting member driving piece. The limiting member rotation shaft is rotatable relative to the second axial direction, is arranged in the housing and located at one side of the dual-code-variable lock core, and partially penetrates the housing and is connected to one end of the baffle plate for driving the baffle plate to rotate relative to the second axial direction. The limiting member driving piece is arranged in the housing and located at one side of the dual-code-variable lock core, is separately connected to the limiting member rotation shaft, the first control member, and the second control member, and is rotatable relative to the second axial direction and is movable in the second axial direction.

In the embodiments of the present utility model, a second unlocking component includes a limiting end portion toward the limiting member driving piece, the limiting member driving piece includes a limiting flange, and when the second control member moves toward the limiting member rotation shaft until the limiting flange is located at the other side of the limiting end portion relative to the first code component, the limiting flange may stop the limiting end portion from moving toward the limiting member driving piece to make an engaging member separated from an engaging portion.

### BRIEF DESCRIPTION OF THE DRAWINGS

FIG. 1A and FIG. 1B are schematic exploded views of an embodiment of a dual-code-variable lock core of the present utility model.

FIG. 2A and FIG. 2B are schematic diagrams of the embodiment of the dual-code-variable lock core of the present utility model.

FIG. 3A and FIG. 3B are schematic diagrams of an embodiment of a first password component being separated from a code wheel in the dual-code-variable lock core of the present utility model.

FIG. 4A to FIG. 4C are schematic diagrams of an embodiment of a second unlocking component being engaged with a second code component in the dual-code-variable lock core of the present utility model.

FIG. 5A and FIG. 5B are schematic exploded views of an embodiment of a first elastic member and a second elastic member included in the dual-code-variable lock core of the present utility model.

FIG. 5C is a schematic diagram of the embodiment of the first elastic member and the second elastic member included in the dual-code-variable lock core of the present utility model.

FIG. 6A and FIG. 6B are schematic diagrams of an embodiment of a dual-code-variable combination lock of the present utility model.

FIG. 6C and FIG. 6D are schematic exploded views of the embodiment of the dual-code-variable combination lock of the present utility model.

FIG. 7A and FIG. 7B are schematic diagrams of an embodiment of assembly of some components in the dual-code-variable combination lock of the present utility model.

FIG. 8A to FIG. 8C are schematic diagrams of an embodiment of an end portion being fixed in a first peripheral surface concave portion in the dual-code-variable combination lock of the present utility model.

FIG. 9A to FIG. 9C are schematic diagrams of an embodiment of a first password component driving piece entering a second peripheral surface concave portion in the dual-code-variable combination lock of the present utility model.

FIG. 10A to FIG. 10D are schematic diagrams of an embodiment of an engaging member being engaged with an engaging portion in the dual-code-variable combination lock of the present utility model.

FIG. 11A to FIG. 11E are schematic diagrams of an embodiment of a limiting flange being located at the other side of a limiting end portion relative to a first password component in the dual-code-variable combination lock of the present utility model.

### DETAILED DESCRIPTION

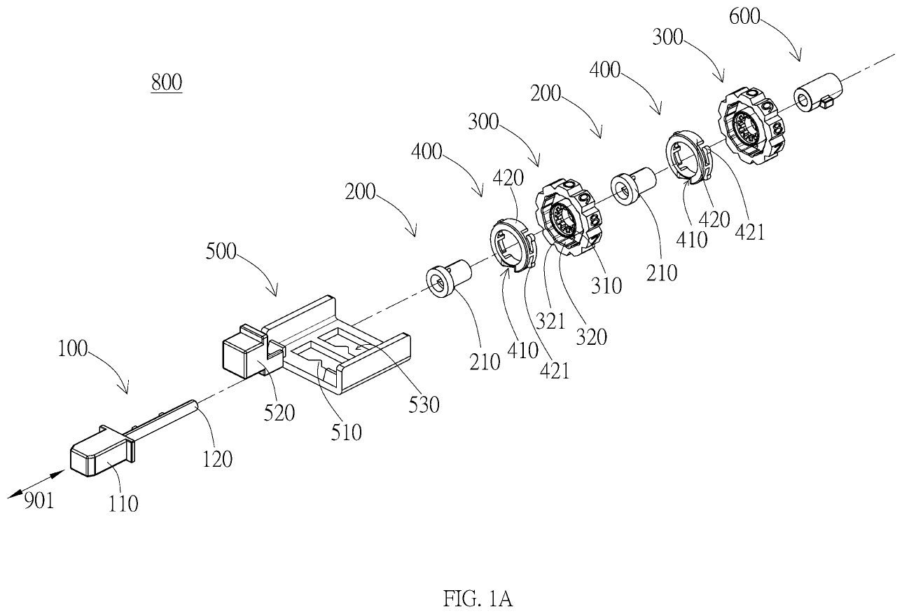

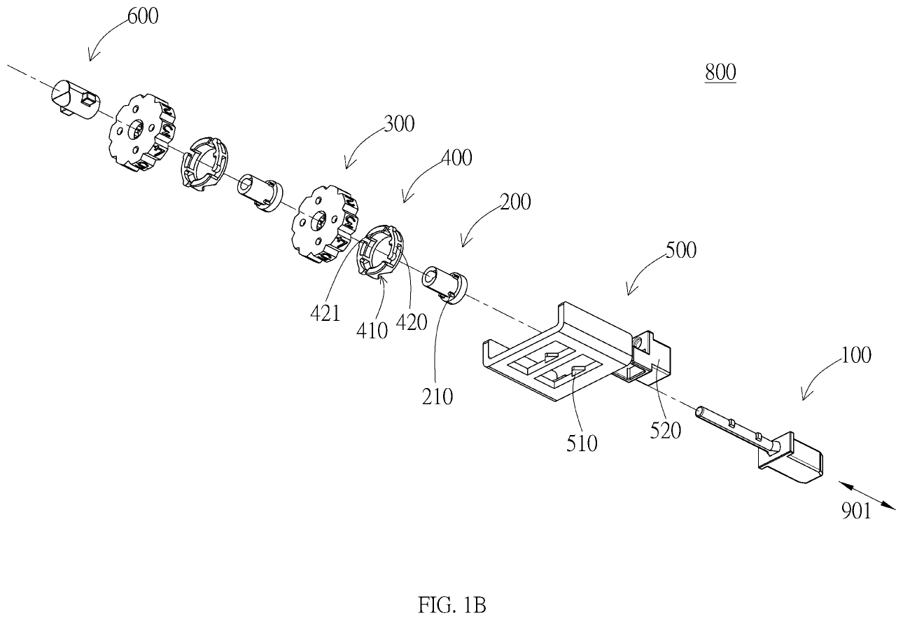

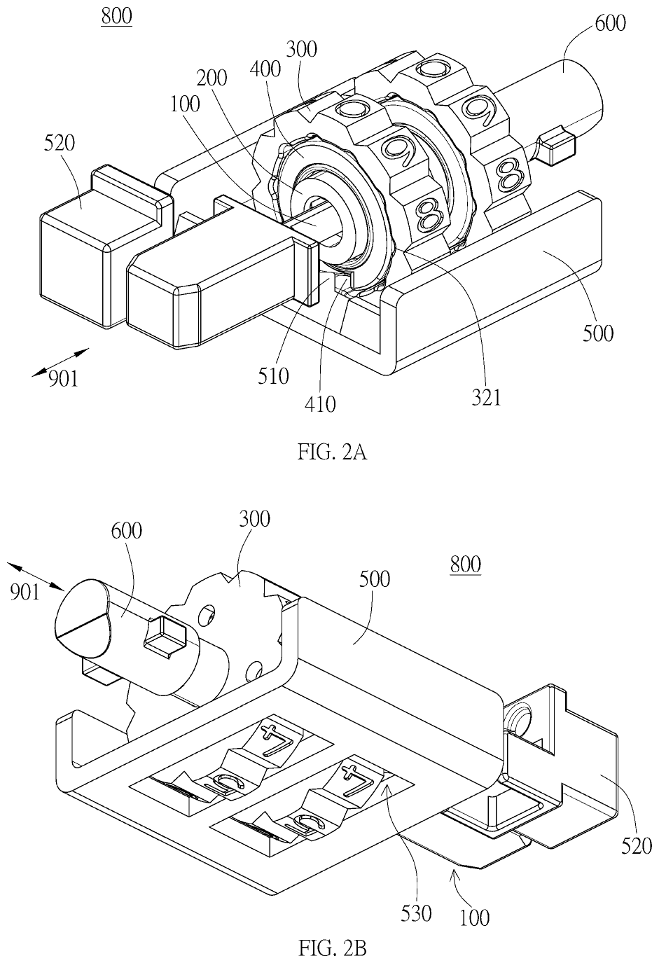

In an embodiment shown in FIG. 1A to FIG. 2B, a dual-code-variable lock core 800 of the present utility model includes a first code component 200, a code wheel 300 arranged outside the first code component 200, and a second code component 400 arranged at one side of the code wheel 300. When the code wheel 300 rotates to a first unlocking position, the first code component 200 may move to perform a code change on the dual-code-variable lock core 800; and when the code wheel 300 rotates to a second unlocking position, the second code component 400 may move to perform the code change on the dual-code-variable lock core 800. Quantities of code wheels 300, and first code components 200 and second code components 400 corresponding to the code wheels 300 are two groups. However, in different embodiments, the quantities may be adjusted according to considerations such as use, design, and manufacture. For example, to increase the difficulty of unlocking, the quantities are increased; or to reduce the volume, reduce the manufacturing costs, and the like, the quantities are reduced.

More specifically, in the embodiment shown in FIG. 1A to FIG. 2B, the dual-code-variable lock core 800 further includes a first unlocking component 100 and a second unlocking component 500. The first unlocking component 100 extends in a first axial direction 901, and is a shaft rod, but is not limited thereto. An end portion 110 of the first unlocking component 100 may be configured to receive an external force, or abut against or be connected to the outside. The first code component 200 is sleeved on the first unlocking component 100, the code wheel 300 is sleeved outside the first code component 200, and the second code component 400 is arranged in the code wheel 300 in a manner of surrounding the first code component 200. The second code component 400 is synchronously rotatable with the code wheel 300 through a second code component acting force between the second code component 400 and the code wheel 300. When the code wheel 300 rotates to the first unlocking position, the first unlocking component 100 may move in the first axial direction 901. When the code wheel 300 rotates to the first unlocking position, the first code component 200 may move to be separated from or engaged with the code wheel 300. When the code wheel 300 rotates to the second unlocking position, the second unlocking component 500 may move to be separated from or engaged with the second code component 400.

Further, the first code component 200 is preferably, but not limited to, a sleeve, and is provided with a first code component outer edge convex piece 210; the code wheel 300 is provided with a first inner edge 310 and a second inner edge 320; and when the first code component 200 is engaged with the code wheel 300, the first code component outer edge convex piece 210 is sleeved in the first inner edge 310. The second code component 400 is arranged in the second inner edge 320 of the code wheel 300 in the manner of surrounding the first code component 200, and is provided with a second code component outer edge 420 and an engaging portion 410. The second code component 400 is synchronously rotatable with the code wheel 300 through a second code component acting force between the second code component outer edge 420 and the second inner edge 320. The second code component acting force may be a friction or an elastic force between contact components, or a magnetic force between non-contact components with magnetic forces.

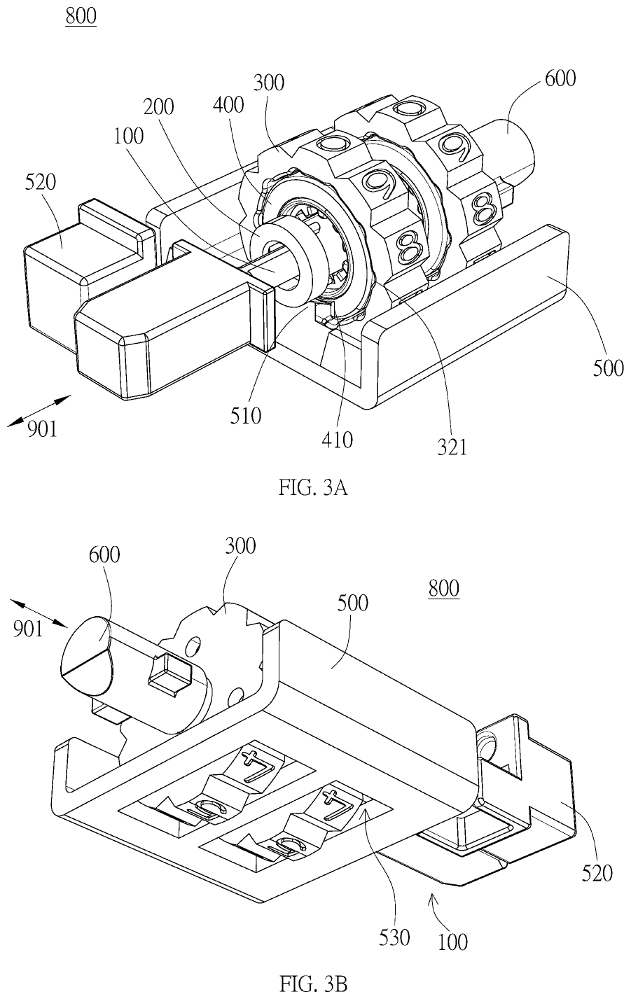

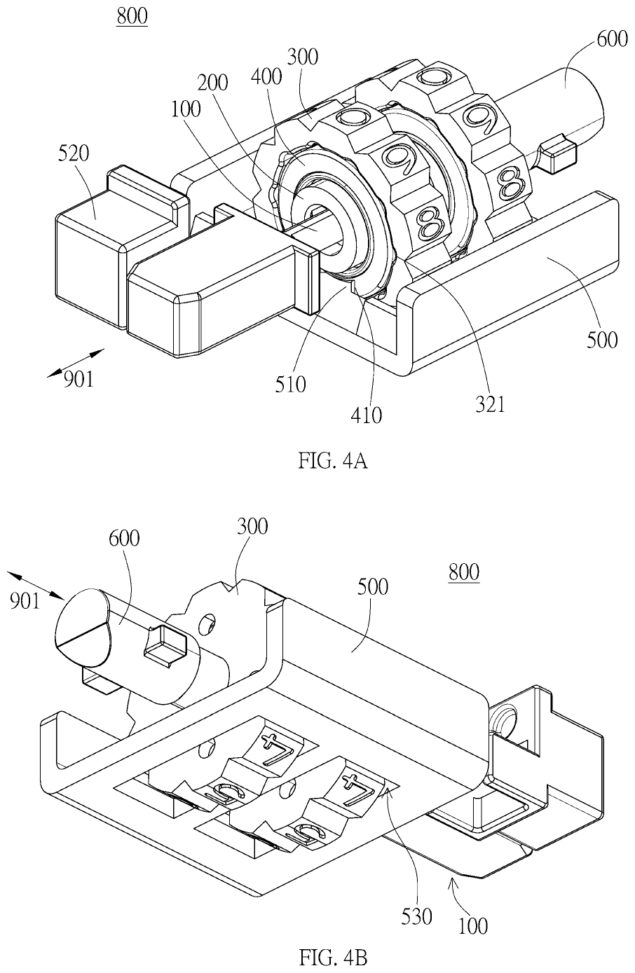

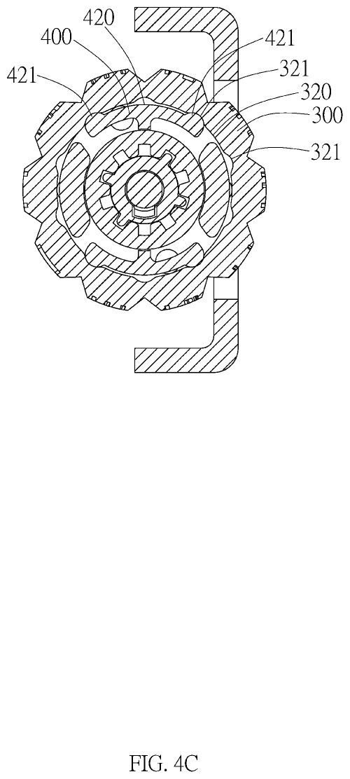

In an embodiment shown in FIG. 3A and FIG. 4B, when the code wheel 300 rotates to the first unlocking position, for example, a first unlocking code combination, relative to the first unlocking component 100, the first unlocking component 100 may move in the first axial direction 901 relative to the code wheel 300, the first code component 200 may move to be separated from or engaged with the code wheel 300, and the second unlocking component 500 may move to be separated from or engaged with the second code component 400. The dual-code-variable lock core 800 further includes one end 120 of a first code component driving piece 600 arranged on the first unlocking component 100, and the first code component driving piece 600 may drive the first code component 200 to move in the first axial direction 901.

In the embodiment shown in FIG. 3A and FIG. 3B, when the first code component 200 is separated from the code wheel 300, the code wheel 300 is independently rotatable relative to the first code component 200 for a code change. More specifically, when the code wheel 300 is located in the first unlocking position, the first code component 200 may move in the first axial direction 901 to make the first code component outer edge convex piece 210 separated from or engaged with the first inner edge 310. In this embodiment, corresponding engaging units are separately arranged on surfaces of the first code component outer edge convex piece 210 and the first inner edge 310, and when the first code component outer edge convex piece 210 is separated from the first inner edge 310, the code wheel 300 may rotate independently relative to the first code component 200 for the code change. A structure of a part of the first code component 200 corresponding to the code wheel 300 and a manner of the code change are conventionally known, and are not described herein.

In an embodiment shown in FIG. 4A and FIG. 4B, the second unlocking component 500 is provided with an engaging member 510. When the code wheel 300 is located in the second unlocking position, for example, a second unlocking code combination, the second unlocking component 500 may move in the first axial direction 901 to make the engaging member 510 separated from or engaged with the engaging portion 410. The first unlocking position and the second unlocking position may be the same or different, i.e., a user may set to make the first unlocking code combination and the second unlocking code combination the same or different. Further, the first unlocking position and the second unlocking position are independently defined, i.e., there is no fixed relationship between the first unlocking code combination and the second unlocking code combination.

In the embodiment shown in FIG. 4A to FIG. 4C, the second unlocking component 500 may be provided with a stress portion 520 for receiving an external force, or may be provided with a hollow portion 530 for at least a part of the code wheel 300 and the second code component 400 to penetrate, to reduce an occupied entire space. When the second unlocking component 500 is engaged with the second code component 400, because the second unlocking component 500 restricts the rotation of the second code component 400, the code wheel 300 is capable of being pushed by an external force which is greater than the second code component acting force for rotating independently relative to the second code component 400 for the code change. More specifically, in the embodiment shown in FIG. 4C, the second code component outer edge 420 is further provided with an elastic convex portion 421, the second inner edge 320 is provided with a limiting concave portion 321, and the second code component 400 is rotatable to make the elastic convex portion 421 at least partially enter the limiting concave portion 321. The elastic convex portion 421 is preferably, but not limited to, a convex piece provided with an elastic arm at an end portion. The external force applied to the code wheel 300 needs to be enough to overcome an elastic force of the elastic convex portion 421, so that the limiting concave portion 321 is disengaged from the elastic convex portion 421, to make the code wheel 300 rotate.

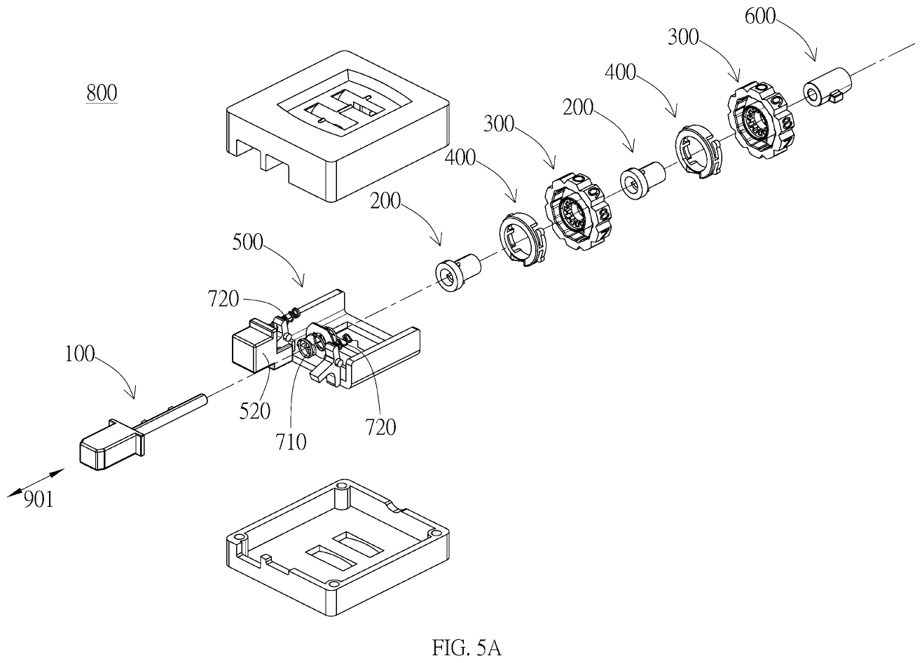

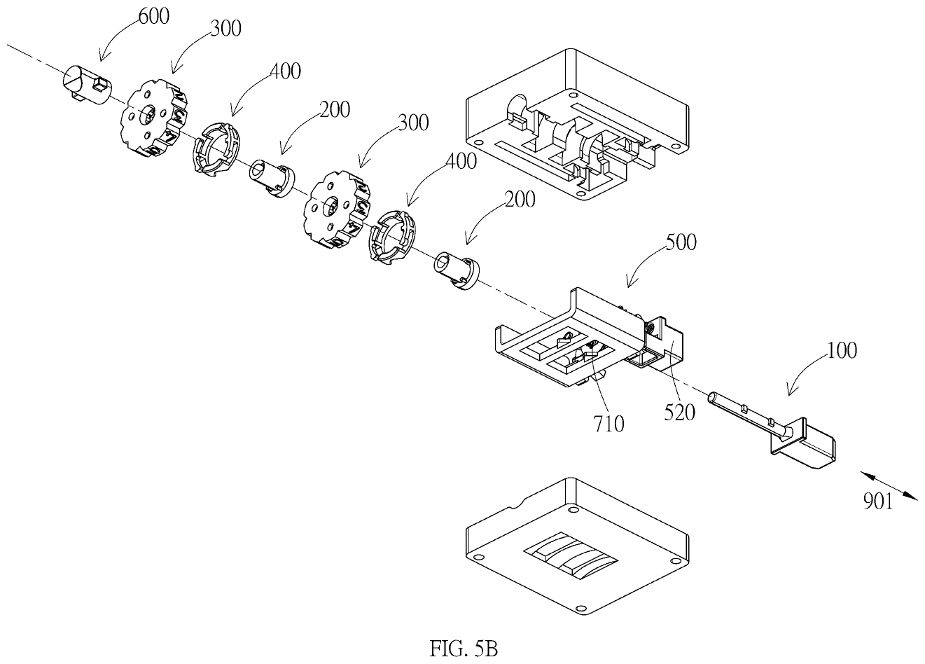

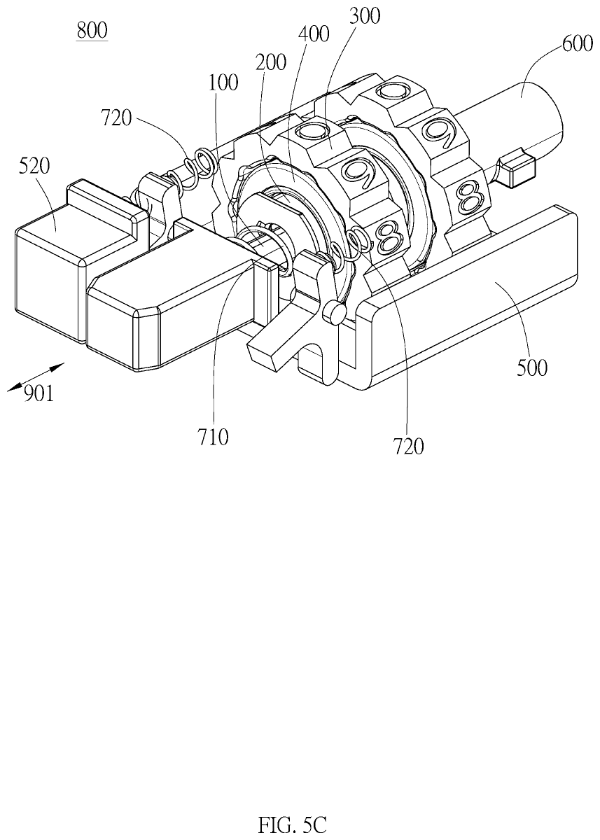

In an embodiment shown in FIG. 5A to FIG. 5C, the dual-code-variable lock core 800 further includes a first elastic member 710, to provide an elastic force acting on the first unlocking component 100 and the first code component 200 in the first axial direction 901. The dual-code-variable lock core 800 further includes a second elastic member 720, to provide an elastic force acting on the second unlocking component 500 in the first axial direction 901. Further, when the first unlocking component 100 moves, under an external force, in the first axial direction 901 to make the end portion 110 close to the code wheel 300, the first elastic member 710 is compressed to generate an elastic force, and when the external force disappears, the elastic force pushes the first unlocking component 100 to move to make the end portion 110 away from the code wheel 300. When the first code component driving piece 600 is driven by an external force to make the first code component 200 move in the first axial direction 901 to be close to the end portion 110, the first elastic member 710 is compressed to generate an elastic force, and when the external force disappears, the elastic force pushes the first code component 200 and the first code component driving piece 600 to move in the first axial direction 901 to be away from the end portion 110. When the second unlocking component 500 moves, under an external force, in the first axial direction 901 to make the engaging member 510 close to the engaging portion 410, the second elastic member 720 is compressed to generate an elastic force, and when the external force disappears, the elastic force pushes the second unlocking component 500 to move to make the engaging member 510 away from the engaging portion 410.

In an embodiment, the dual-code-variable lock core of the present utility model may be assembled with other components to form a dual-code-variable combination lock. Further, the dual-code-variable combination lock may be a cabinet lock. However, in different embodiments, the dual-code-variable combination lock may be, but is not limited to, a bicycle lock, a box lock, a door lock, an electronic device lock, or the like.

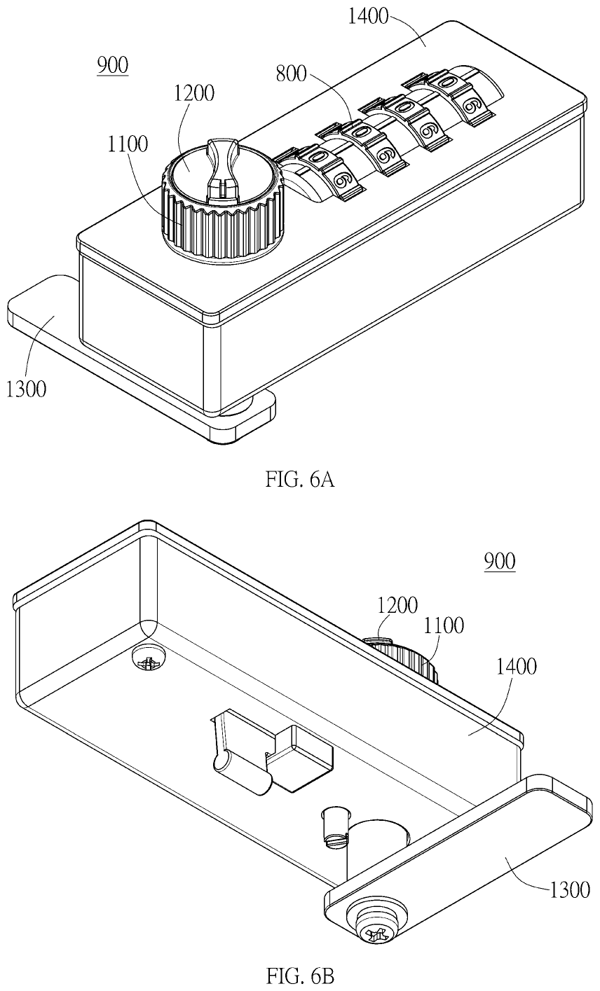

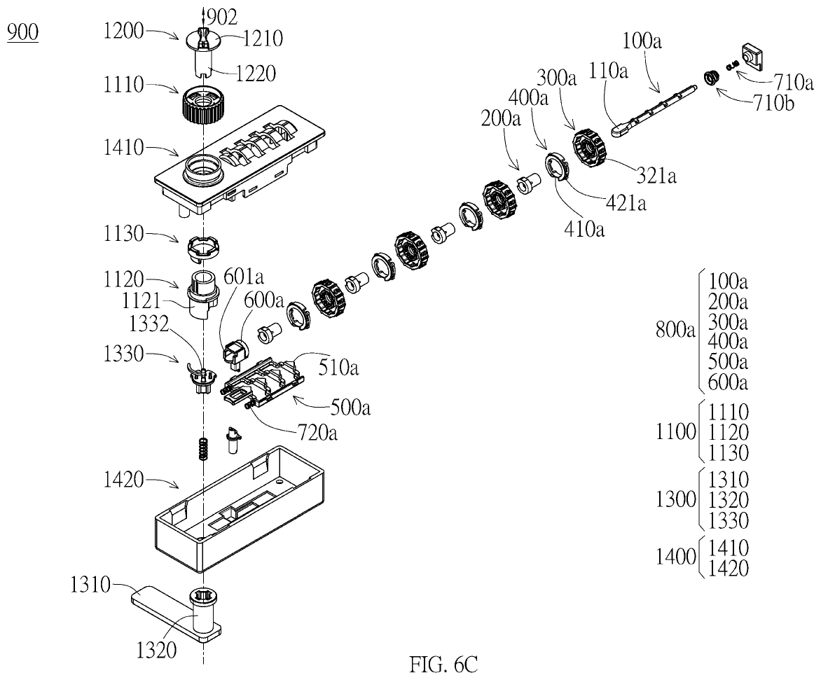

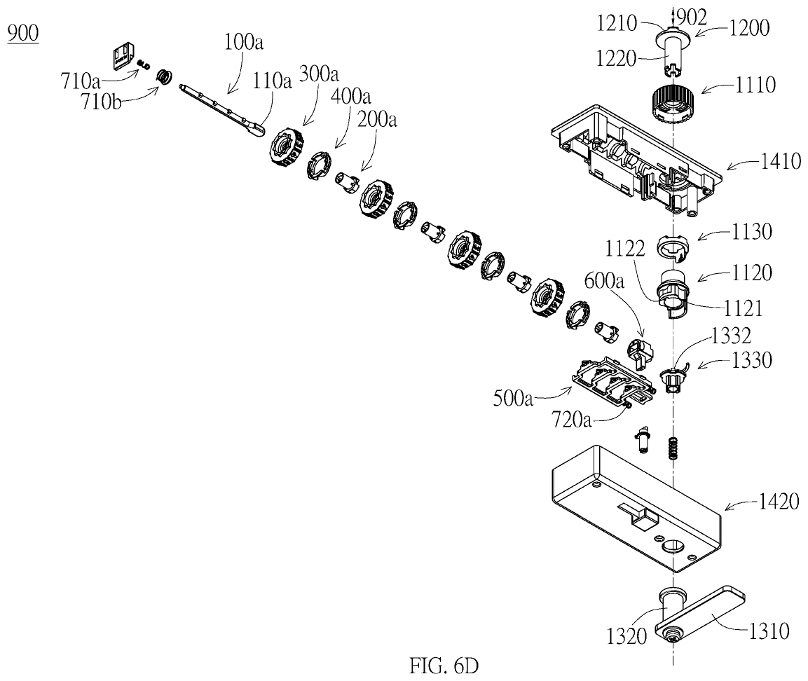

In an embodiment shown in FIG. 6A to FIG. 6D, a dual-code-variable combination lock 900 includes a dual-code-variable lock core 800a, a first control member 1100, a second control member 1200, a limiting member 1300, and a housing 1400. In this embodiment, the housing 1400 includes an upper housing 1410 and a lower housing 1420. However, in different embodiments, the shape, combination or mode of the housing may be adjusted according to the requirement of use, manufacture or design. For example, when the dual-code-variable combination lock is applied to a trunk body, a concave portion may be formed on a trunk shell to arrange components such as the dual-code-variable lock core 800a, the first control member 1100, the second control member 1200, and the limiting member 1300. In this case, side walls of the concave portion of the trunk shell may be regarded as the housing.

The dual-code-variable lock core 800a is arranged in the housing 1400. The limiting member 1300 is inserted into the housing 1400 and located at one side of the dual-code-variable lock core 800a, and is rotatable relative to a second axial direction 902. The first control member 1100 is connected to the limiting member 1300, to control the movement of a first code component 200a and the rotation of the limiting member 1300. The second control member 1200 is connected to the limiting member 1300, to control the movement of a second code component 400a and the rotation of the limiting member 1300.

More specifically, in this embodiment, the limiting member 1300 includes a baffle plate 1310, a limiting member rotation shaft 1320, and a limiting member driving piece 1330. The limiting member rotation shaft 1320 is rotatable relative to the second axial direction 902, is arranged in the housing 1400 and located at one side of the dual-code-variable lock core 800a, and partially penetrates the housing 1400 and is connected to one end of the baffle plate 1310 for driving the baffle plate 1310 to rotate relative to the second axial direction 902. The limiting member driving piece 1330 is arranged in the housing 1400 and located at one side of the dual-code-variable lock core 800a, is separately connected to the limiting member rotation shaft 1320, the first control member 1100, and the second control member 1200, and is rotatable relative to the second axial direction 902 and movable along the second axial direction 902.

In the embodiment shown in FIG. 6A to FIG. 6D, the first control member 1100 includes a first rotation member 1110 and a driving cylinder 1120. The first rotation member 1110 is rotatable relative to the second axial direction 902, and is arranged at the other side of the housing 1400 relative to the limiting member 1300. The driving cylinder 1120 is rotatable relative to the second axial direction 902, and two opposite ends of the driving cylinder 1120 are separately connected to the first rotation member 1110 and the limiting member driving piece 1330. The first control member 1100 may further include a first control member connecting piece 1130, and the driving cylinder 1120 is connected to the first rotation member 1110 through the first control member connecting piece 1130.

In the embodiment shown in FIG. 6A to FIG. 6D, the second control member 1200 is rotatable relative to the second axial direction 902 and move in the second axial direction 902, is arranged at the other side of the housing 1400 relative to the limiting member 1300, and is provided with a second rotation member 1210 and a second control member rotation shaft 1220 that are connected to each other, and the second control member rotation shaft 1220 penetrates the housing 1400 and the first rotation member 1110 and is connected to the limiting member driving piece 1330. A fixing portion 1122 is provided on a bottom portion of the driving cylinder 1120, a fixing member 1332 corresponding to the fixing portion 1122 is provided on a top portion of the limiting member driving piece 1330, and the second control member 1200 may move toward the limiting member rotation shaft 1320 to make the fixing portion 1122 separated from the fixing member 1332.

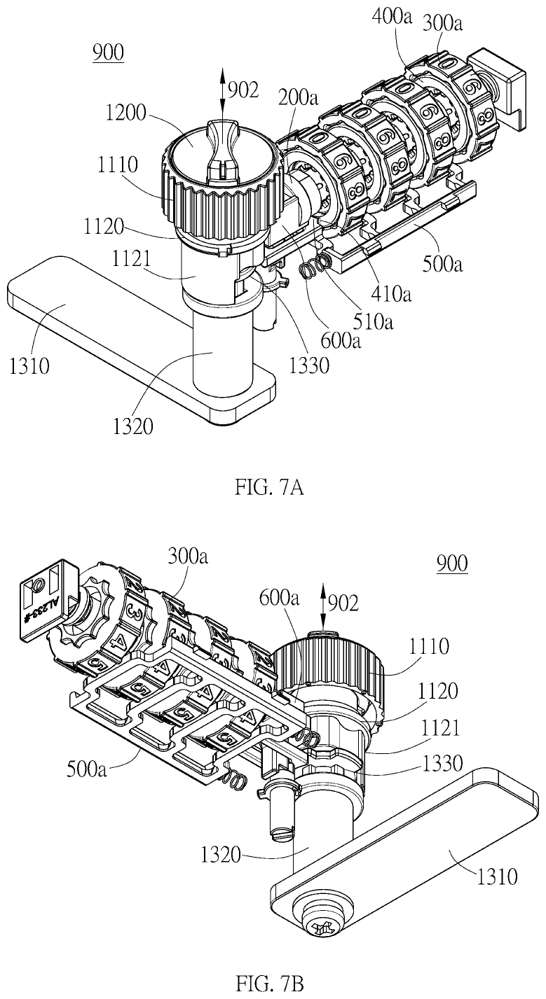

In an embodiment, a structure of the dual-code-variable combination lock 900 of the present utility model after assembly is shown in FIG. 7A and FIG. 7B. For clarity and ease of understanding, some components such as the housing are not shown in FIG. 7A and FIG. 7B and figures below. An actuation manner of the dual-code-variable combination lock 900 of this embodiment is further described below.

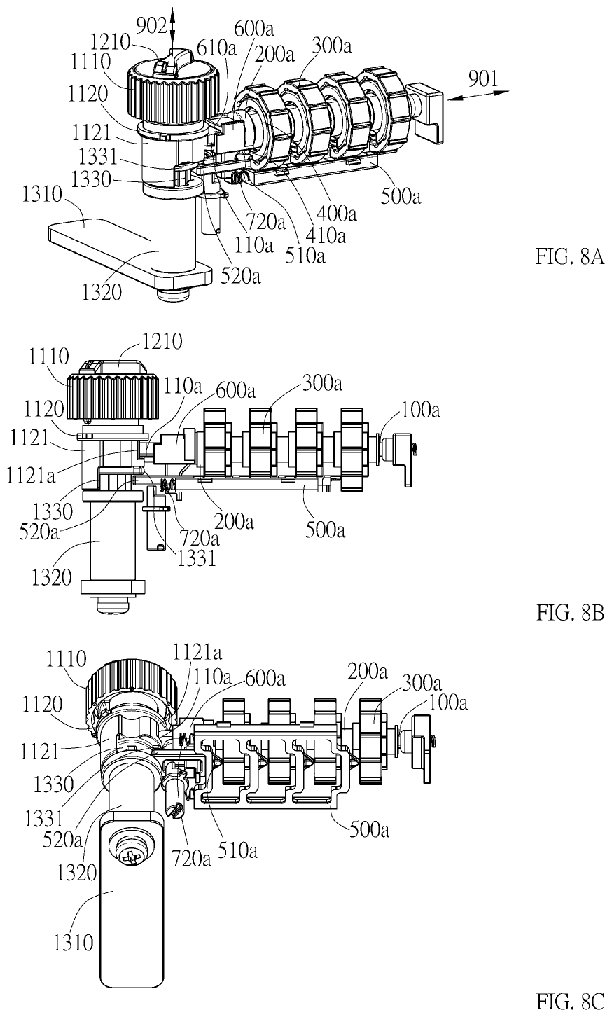

In an embodiment shown in FIG. 8A to FIG. 8C, the baffle plate 1310 is located in a locked position of the limiting member, and an end portion 110a of a first unlocking component 100a and a first code component driving piece 600a separately abut against a peripheral surface 1121 of the driving cylinder 1120. The end portion 110a may penetrate the first code component driving piece 600a through a hole 601a to enter a first peripheral surface concave portion 1121a. An elastic member 710a (referring to FIG. 6C and FIG. 6D) provides an elastic force in a first axial direction 901 to make the first unlocking component 100a move toward the driving cylinder 1120. In this case, if the code wheel 300a is not located in a first unlocking position, the first unlocking component 100a cannot move in the first axial direction 901. Therefore, the end portion 110a is fixedly located in the first peripheral surface concave portion 1121a, to restrict rotation of the driving cylinder 1120. In addition, one end of the first code component driving piece 600a abuts against the peripheral surface 1121 of the driving cylinder 1120, so that the first code component 200a is close to the code wheel 300a and engaged with the code wheel 300a. Therefore, the code wheel 300a cannot rotate independently relative to the first code component 200a for a code change. In addition, a second unlocking component 500a is not engaged with the second code component 400a, and the second unlocking component 500a does not restrict rotation of the second code component 400a. Therefore, the code wheel 300a is synchronously rotatable with the second code component 400a through, for example, an elastic force of an elastic convex portion 421a (referring to FIG. 6C) in a limiting concave portion 321a, and the code change is not performed.

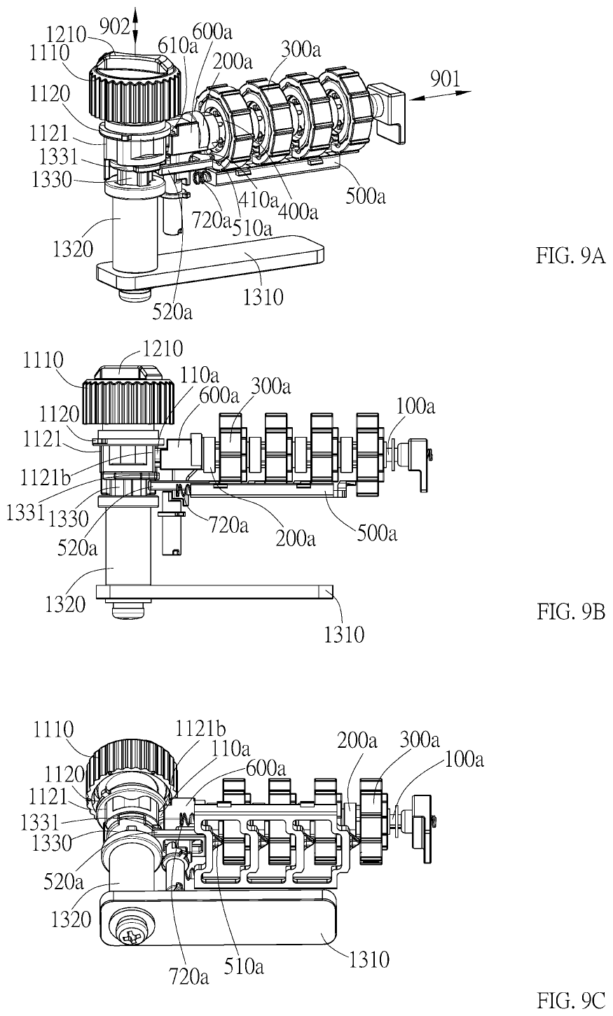

In an embodiment shown in FIG. 9A to FIG. 9C, if the code wheel 300a is located in the first unlocking position, the first unlocking component 100a may move in the first axial direction 901. Therefore, the end portion 110a does not restrict the rotation of the driving cylinder 1120. The user may rotate, by rotating the first rotation member 1110, the driving cylinder 1120 to the first code component driving piece 600a to enter a second peripheral surface concave portion 1121b, so that the first code component 200a is separated from the code wheel 300a. Therefore, the code wheel 300a is independently rotatable relative to the first code component 200a for the code change. An elastic member 710b provides an elastic force in the first axial direction 901 to make the first code component driving piece 600a and the first code component 200a move toward the driving cylinder 1120. On the other hand, in this case, the second unlocking component 500a is not engaged with the second code component 400a, and the second unlocking component 500a does not restrict the rotation of the second code component 400a. Therefore, the code wheel 300a is synchronously rotatable with the second code component 400a, and the code change cannot be performed.

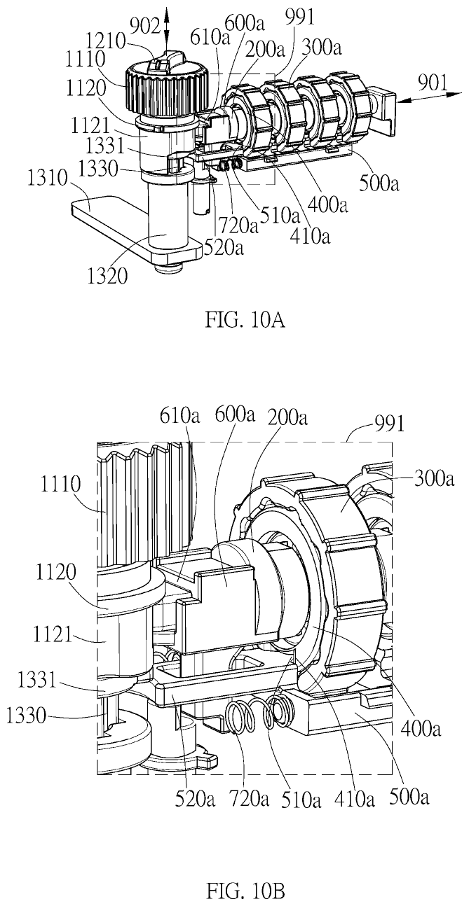

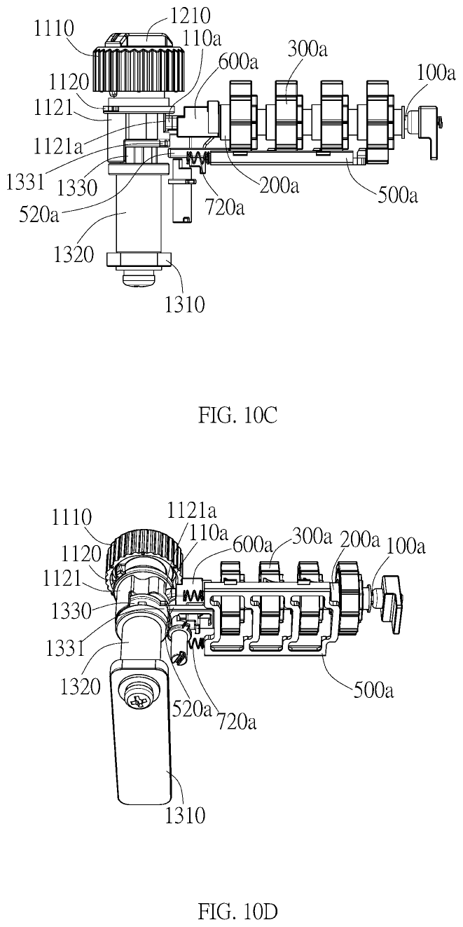

In an embodiment shown in FIG. 10A and FIG. 10B, FIG. 10B is an enlarged view of a region 991 in FIG. 10A. If the code wheel 300a is located in a second unlocking position, engaging portions 410a of all second code components 400a correspond to engaging members 510a. Therefore, the second unlocking component 500a moves in the first axial direction 901, to make the engaging members 510a enter the engaging portions 410a and be engaged with the engaging portions 410a. An elastic member 720a provides an elastic force in the first axial direction 901 to make the engaging members 510a move toward the engaging portions 410a, i.e., the engaging members 510a are away from the driving cylinder 1120. In this case, in an embodiment shown in FIG. 10C and FIG. 10D, a limiting end portion 520a of the second unlocking component 500a leaves between a limiting flange 1331 of the limiting member driving piece 1330 and the limiting member rotation shaft 1320.

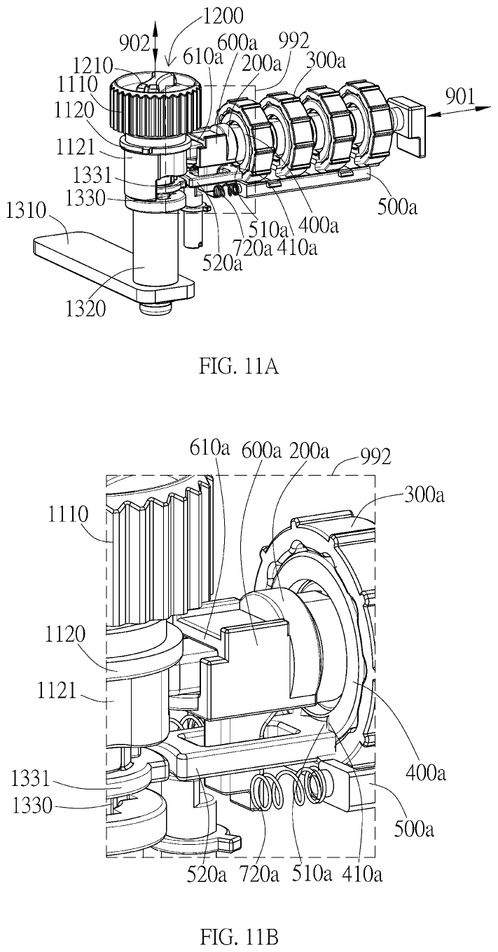

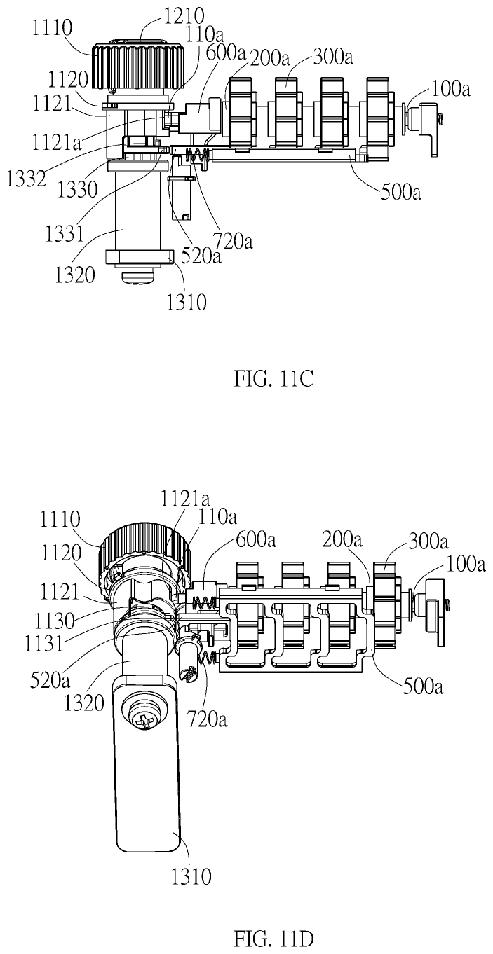

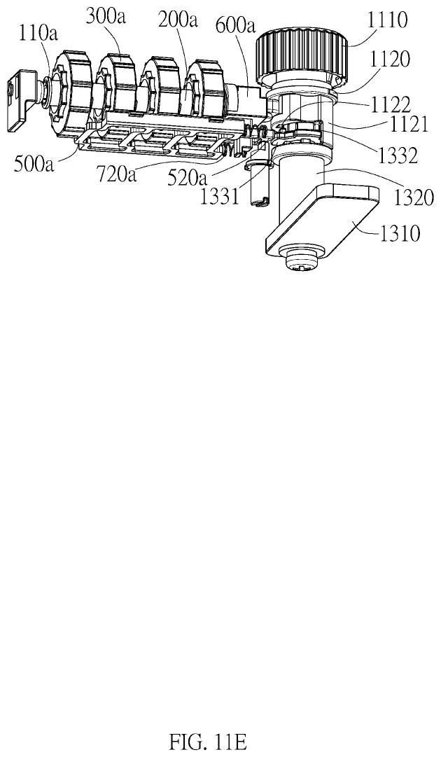

In an embodiment shown in FIG. 11A to FIG. 11E, FIG. 11B is an enlarged view of a region 992 in FIG. 11A. The first code component driving piece 600a abuts against the peripheral surface 1121 of the driving cylinder 1120, so that the first code component 200a is engaged with the code wheel 300a. Therefore, the code wheel 300a cannot rotate independently relative to the first code component 200a for the code change. Correspondingly, the code wheel 300a is located in the second unlocking position, engaging portions 410a of all second code components 400a correspond to engaging members 510a. Therefore, the second unlocking component 500a moves in the first axial direction 901, to make the engaging members 510a engaged with the engaging portions 410a. On the other hand, when the second control member 1200 moves toward the limiting member rotation shaft 1320 until the limiting flange 1331 is located at the other side of the limiting end portion 520a relative to the first code component 200a, the limiting flange 1331 may stop the limiting end portion 520a from moving toward the limiting member driving piece 1330 to make the engaging members 510a separated from the engaging portions 410a. In other words, in this case, the second unlocking component 500a is engaged with the second code component 400a, and the second unlocking component 500a restricts the rotation of the second code component 400a. Therefore, the code wheel 300a may be pushed by an external force greater than the second code component acting force, to independently rotate relative to the second code component 400a for the code change.

Although the foregoing description and drawings have disclosed exemplary embodiments of the present utility model, it should be understood that various additions, many modifications, and substitutions may be made thereto without departing from the spirit and scope of the principles of the present utility model as defined by the appended claims. Those ordinarily skilled in the art of the present utility model will appreciate that the present utility model is applicable to modifications of many forms, structures, arrangements, proportions, materials, components, and components. Therefore, the embodiments disclosed herein should be considered as illustrative and not restrictive of the present utility model. The scope of the present utility model should be defined by the appended claims, and covers the legal equivalents thereof, but is not limited to the foregoing descriptions.

1. A dual-code-variable lock core, comprising:
a first code component;
a code wheel, arranged outside the first code component; and
a second code component, arranged at one side of the code wheel, wherein
when the code wheel rotates to a first unlocking position, the first code component moves to perform a code change on the dual-code-variable lock core; and when the code wheel rotates to a second unlocking position, the second code component moves to perform the code change on the dual-code-variable lock core.

2. The dual-code-variable lock core according to claim 1, further comprising:
a first unlocking component, extending in a first axial direction, wherein the first code component is sleeved on the first unlocking component, the code wheel is sleeved outside the first code component, the second code component is arranged in the code wheel in a manner of surrounding the first code component, and the second code component is synchronously rotatable with the code wheel through a second code component acting force between the second code component and the code wheel; and
a second unlocking component, arranged at an outer side of the code wheel, wherein
when the code wheel rotates to the first unlocking position, the first code component moves to be separated from or engaged with the code wheel; and when the code wheel rotates to the second unlocking position, the second unlocking component moves to be separated from or engaged with the second code component.

3. The dual-code-variable lock core according to claim 1, wherein the first unlocking position and the second unlocking position are independently defined.

4. The dual-code-variable lock core according to claim 2, wherein
when the first code component is separated from the code wheel, the code wheel is independently rotatable relative to the first code component; and
when the second unlocking component is engaged with the second code component, the code wheel is capable of being pushed by an external force which is greater than the second code component acting force for rotating independently relative to the second code component.

5. The dual-code-variable lock core according to claim 4, wherein
the first code component is provided with a first code component outer edge convex piece;
the code wheel is provided with a first inner edge and a second inner edge;
the second code component is arranged in the second inner edge of the code wheel in the manner of surrounding the first code component, and is provided with a second code component outer edge and an engaging portion, and the second code component is synchronously rotatable with the code wheel through a second code component acting force between the second code component outer edge and the second inner edge;
the second unlocking component is provided with an engaging member; and
when the code wheel is located in the first unlocking position, the first code component moves in the first axial direction to make the first code component outer edge convex piece separated from or engaged with the first inner edge; and when the code wheel rotates to the second unlocking position, the second unlocking component moves in the first axial direction to make the engaging member separated from or engaged with the engaging portion.

6. The dual-code-variable lock core according to claim 5, wherein
when the first code component outer edge convex piece is separated from the first inner edge, the code wheel independently rotates relative to the first code component; and
when the engaging member is engaged with the engaging portion, the code wheel is pushed by the external force, to independently rotate relative to the second code component.

7. The dual-code-variable lock core according to claim 5, wherein the second code component outer edge is provided with an elastic convex portion, the second inner edge is provided with a limiting concave portion, and the second code component is rotatable to make the elastic convex portion at least partially enter the limiting concave portion.

8. A dual-code-variable combination lock, comprising:
a housing;
the dual-code-variable lock core according to claim 1, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

9. The dual-code-variable combination lock according to claim 8, wherein the limiting member comprises:
a baffle plate;
a limiting member rotation shaft, is rotatable relative to the second axial direction, arranged in the housing and located at one side of the dual-code-variable lock core, and partially penetrating the housing and connected to one end of the baffle plate for driving the baffle plate to rotate relative to the second axial direction; and
a limiting member driving piece, arranged in the housing and located at one side of the dual-code-variable lock core, separately connected to the limiting member rotation shaft, the first control member, and the second control member, and is rotatable relative to the second axial direction and movable along the second axial direction.

10. The dual-code-variable combination lock according to claim 9, wherein a second unlocking component comprises a limiting end portion toward the limiting member driving piece, the limiting member driving piece comprises a limiting flange, and when the second control member moves toward the limiting member rotation shaft until the limiting flange is located at the other side of the limiting end portion relative to the first code component, the limiting flange stops the limiting end portion from moving toward the limiting member driving piece to make an engaging member separated from an engaging portion.

11. A dual-code-variable combination lock, comprising:
a housing;
the dual-code-variable lock core according to claim 2, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

12. A dual-code-variable combination lock, comprising:
a housing;
the dual-code-variable lock core according to claim 3, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

13. A dual-code-variable combination lock, comprising:
a housing;
the dual-code-variable lock core according to claim 4, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

14. A dual-code-variable combination lock, comprising:
a housing;
the dual-code-variable lock core according to claim 5, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

15. A dual-code-variable combination lock, comprising:
a housing;
the dual-code-variable lock core according to claim 6, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.

16. A dual-code-variable combination lock, comprising:
a housing;
the dual-code-variable lock core according to claim 7, arranged in the housing;
a limiting member, inserted into the housing and located at one side of the dual-code-variable lock core, and is rotatable relative to a second axial direction;
a first control member, connected to the limiting member, to control the movement of the first code component and the rotation of the limiting member; and
a second control member, connected to the limiting member, to control the movement of the second code component and the rotation of the limiting member.
